(19) United States
(12) Patent Application Publication
(10) Pub. No.: US 2013/0270906 A1
(43) Pub. Date: Oct. 17, 2013

(54) UNINTERRUPTIBLE ILLUMINATION SYSTEM

(71) Applicant: CHING-NAN YANG, New Taipei City (TW)

(72) Inventor: CHING-NAN YANG, New Taipei City (TW)

(21) Appl. No.: 13/444,871

(22) Filed: Apr. 12, 2012

(51) Int. Cl. H02J 9/00

(52) U.S. Cl. 307/23

(57) ABSTRACT

The uninterruptible illumination system contains at least a lighting device and a power detection device which is connected to a power supply line. There is a light generation element and a driver and communication module in each lighting device. The power detection device is wireless-linked with the driver and communication module. The power detection device detects the electrical condition on the power supply line. When the voltage on the power supply line is normal, at least a light device is able to provide illumination. On the other hand, when the voltage on the power supply line is not normal or there is no electricity, the driver and communication module receives a signal from a wireless transmitter of the power detection device, the stored electricity of an electricity provision unit of the driver and communication module is used to maintain the operation of the light generation element.

### TECHNICAL FIELD OF THE INVENTION

The present invention is generally related to illumination systems, and more particular to an illumination system capable of providing uninterruptible illumination when the supply of electricity is interrupted.

### DESCRIPTION OF THE PRIOR ART

Devices for emergency lighting are illumination systems capable of continuously providing appropriate illumination when an emergent event interrupts the supply of electricity, so that people in the household and working environment can take proper action for shelter or escape within a limited time period.

The existing emergency lighting devices are usually installed at the exits and corridor corners. The purpose is that a certain degree of brightness is guaranteed along the escape route even when the electricity is disrupted. In the recent years, as the awareness of household safety increases, more emphasis is placed on the safety side of a building's design, in addition to its comfort side.

The existing emergency lighting devices are usually equipped with some AC/DC switch device. Under normal circumference, an internal battery is charged by a DC power transformed from the AC mains. Once the internal battery is full, the charging is automatically stopped. When the electricity from the mains is disrupted, the AC/DC switch device automatically switches to use electricity from the internal battery for emergency lighting.

### SUMMARY OF THE INVENTION

A major objective of the present invention is to provide an uninterruptible illumination system which is capable of providing illumination when electricity is disrupted.

To achieve the objective, the uninterruptible illumination system contains at least a lighting device. There is a light generation element and a driver and communication module in each lighting device. The driver and communication module contains a wireless receiver, an electricity provision unit for supplying electricity to the light generation element, a driver unit electrically connected to the wireless receiver for activating the electricity provision unit to start electricity provision, and a charging unit for maintaining the storage of electricity of the electricity provision unit. The uninterruptible illumination system further contains a power detection device which is connected to a power supply line and is wireless-linked with the wireless receiver. The light generation element can be such as a halogen lamp, an incandescent lamp, a fluorescent lamp, or a light emitting diode (LED). The lighting device can be embodied in the form of a light bulb, a lamp tube, or a recessed light fixture.

The power detection device detects the electrical condition on the power supply line. When the voltage on the power supply line is normal, meaning that the electrical condition of the power supply line is normal, at least a light device is able to provide illumination. On the other hand, when the voltage on the power supply line is not normal or there is no electricity the driver and communication module receives a signal from a wireless transmitter of the power detection device, the driver unit activates the electricity provision unit whose stored electricity is used to maintain the operation of the light generation element.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing an uninterruptible illumination system according to the present invention.

FIG. 2 is a flow diagram showing a scenario of the operation of the uninterruptible illumination system according to the present invention.

FIG. 3 is a flow diagram showing another scenario of the operation of the uninterruptible illumination system according to the present invention.

FIG. 4 is a schematic diagram showing an embodiment of the uninterruptible illumination system according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

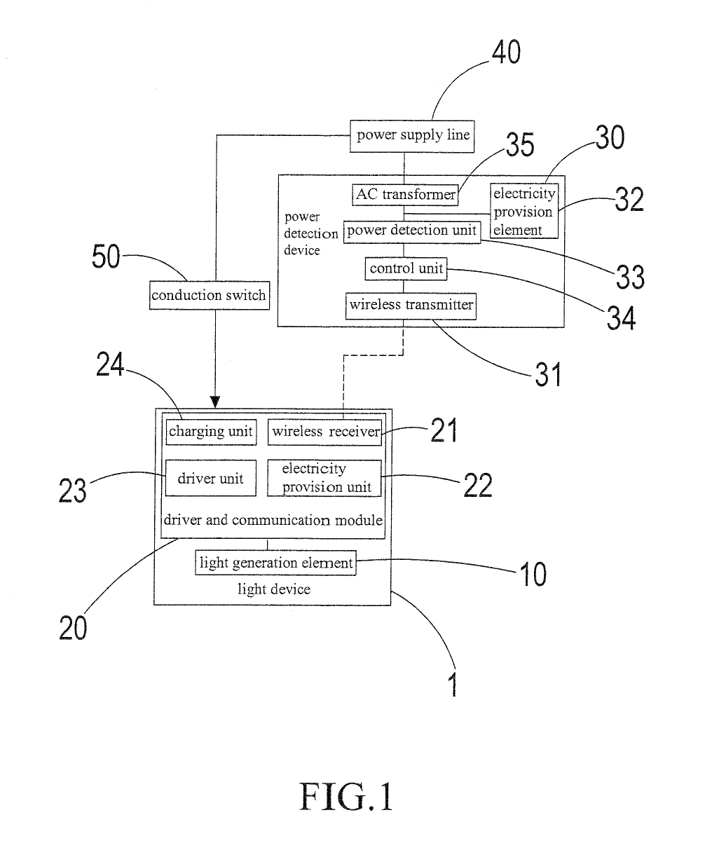

As shown in the functional block diagram of FIG. 1, the uninterruptible illumination system according the present invention contains the following.

There is at least a lighting device 1. There is a light generation element 10 such as a halogen lamp, an incandescent lamp, a fluorescent lamp, or a light emitting diode (LED) in each lighting device 1.

There is a driver and communication module 20 in each lighting device 1 connected to the light generation element, which contains a wireless receiver 21, an electricity provision unit 22 for supplying electricity to the light generation element 10, a driver unit 23 electrically connected to the wireless receiver 21 for activating the electricity provision unit 22 to start electricity provision, and a charging unit 24 for maintaining the storage of electricity of the electricity provision unit 22.

The uninterruptible illumination system further contains a power detection device 30 which is connected to a power supply line 40 and is wireless-linked with the wireless receiver 21.

The power detection device 30 contains the following.

There is a wireless transmitter 31 for radiating a signal to the wireless receiver 21.

There is an electricity provision element 32 for providing electricity to wireless transmitter 31 and other components of the power detection device 30 when abnormality is detected on the power supply line 40.

There is a power detection unit 33 for detecting the electrical condition of the power supply line 40.

There is a control unit 34 for receiving an abnormality signal from the power detection unit 33 and then producing a control signal to the wireless transmitter 31.

There is an AC (alternating current) transformer 35 configured on the power detection device 30 for interfacing the power supply line 40.

Each lighting device 1 of the uninterruptible illumination system is further connected to a conduction switch 50 operable by a user.

The lighting device 1 of the uninterruptible illumination system can be embodied in the form of a light bulb, a lamp tube, or a recessed light fixture.

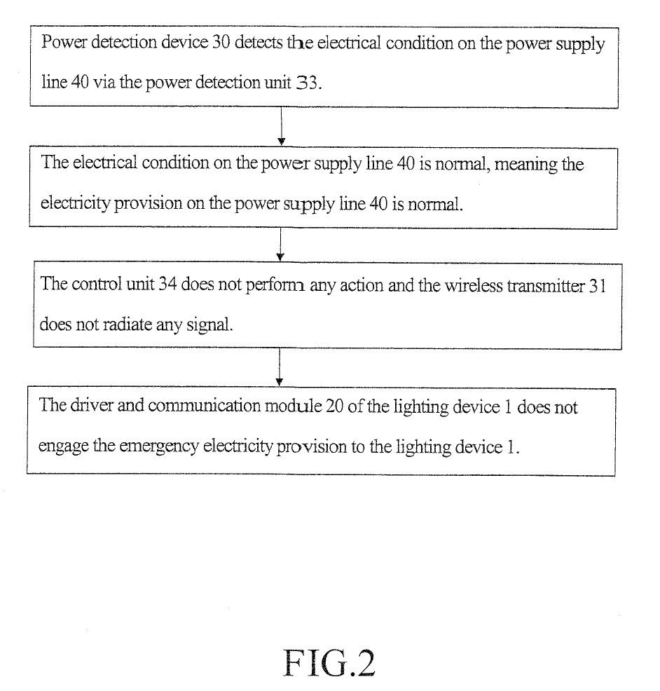

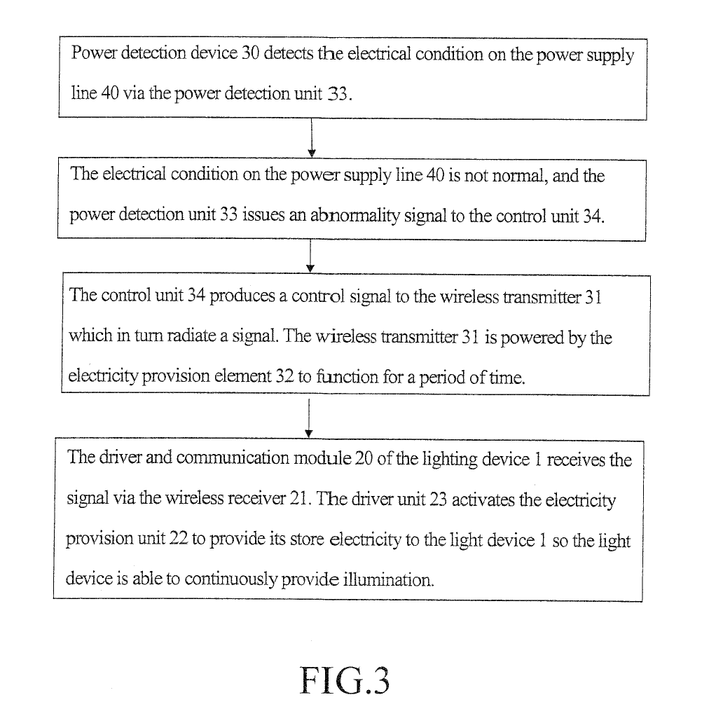

By referencing FIGS. 1 to 3, the operation of the uninterruptible illumination system is as follows. The power detection device 30 detects the electrical condition on the power supply line 40 through the power detection unit 33. When the voltage on the power supply line 40 is normal, meaning that the electrical condition of the power supply line 40 is normal, the power detection unit 33 does not issue any abnormality signal. The control unit 34 therefore does not perform any action and the wireless transmitter 31 does not radiate a signal to the wireless receiver 21. As such the driver and communication module 20 of the uninterruptible illumination system is not activated whereas the charging unit 24 charges the electricity provision unit 22 so as to maintain its electricity. However, if the conduction switch 50 is turned off, the charging unit 24 does not charge the electricity provision unit 22.

On the other hand, when the voltage on the power supply line 40 is not normal or there is no electricity on the power supply line 40, the power detection unit 33 produces an abnormality signal to the control unit 34, which in turn issues a control signal to the wireless transmitter 31. Since the power supply line 40 cannot provide the required electricity, the electricity stored in the electricity provision element 32 (such as a capacitor) is used to power the wireless transmitter 31. As such, even though there is no power from the power supply line 40, the wireless transmitter 31 is able to function for an additional period of time. The length of this period is determined by the design of the electricity provision element 32.

When the driver and communication module 20 receives the wireless transmitter 31's signal from the wireless receiver 21, the driver unit 23 activates the electricity provision unit 22 whose stored electricity is used to maintain the operation of the light generation element 10.

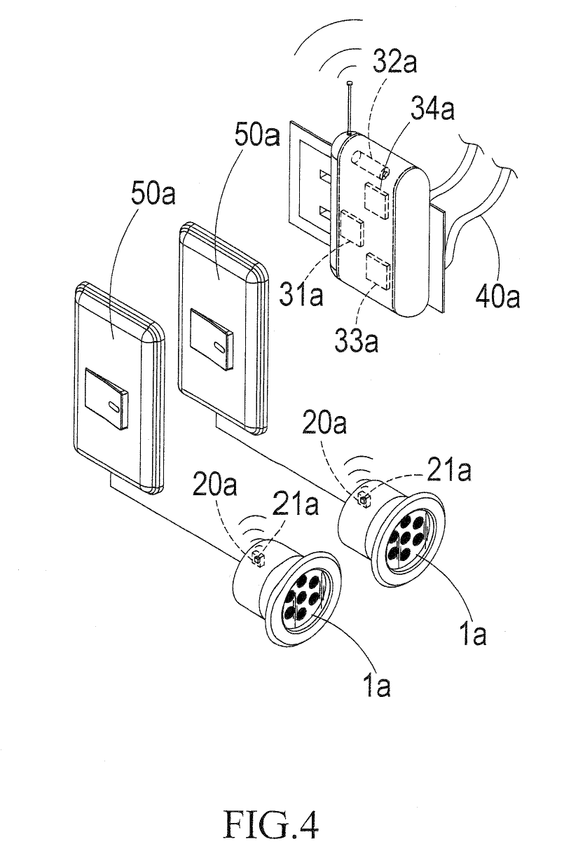

FIG. 4 depicts an embodiment of the present invention. In this embodiment, the electricity provision element 32a is a rechargeable battery and each lighting device 1a is electrically connected to a conduction switch 50a which controls the provision of electricity to the connected light device 1a. When the voltage on the power supply line 40a is not normal or there is no electricity, the power detection unit 33a produces an abnormality signal to the control unit 34a which issues a control signal to the wireless transmitter 31a. As the power supply line 40a cannot supply the required electricity, the electricity stored in the electricity provision element 32a is used to sustain the wireless transmitter 31a to radiate a signal to the wireless receivers 21a. Even though there is no power from the power supply line 40a, the wireless transmitter 31a is able to function for an additional period of time. The length of this period is determined by the design of the electricity provision element 32a.

When a driver and communication module 20a receives the wireless transmitter 31a's signal from its wireless receiver 21a, the associated lighting device 1a is activated for emergency lighting.

The electricity provision element 32a can also be a one-time battery for providing the electricity for a period of time to the wireless transmitter 31a.

Compared to the prior art, the present invention has the following advantages.

Firstly, through the electricity provision element 32, the wireless transmitter 31 can continue to operate even when electricity is disrupted.

Secondly, the probability of the loss of signal and the wrongful activation of the lighting device 1 is effectively reduced and avoided.

Thirdly, the wireless transmitter 31 does not radiate signal when the electrical condition of the power supply line 40 is normal. This greatly reduces power consumption.

Fourthly, the existing electricity provision system remains intact with the additional function of uninterruptible power supply.

Fifthly, the existing power supply line 40 remains intact with the function of uninterruptible power supply added.

Sixthly, multiple lighting devices 1 can be wirelessly activated through their respective driver and communication modules 20 when electricity is disrupted.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An uninterruptible illumination system, comprising at least a lighting device wherein each light device comprises a light generation element and a driver and communication module connected to the light generation element; the driver and communication module comprises:
a wireless receiver;
an electricity provision unit supplying electricity to the light generation element;
a driver unit electrically connected to the wireless receiver for activating the electricity provision unit to start electricity provision; and
a charging unit for maintaining the storage of electricity of the electricity provision unit.

2. The uninterruptible illumination system according to claim 1, further comprising a power detection device connected to a power supply line and wirelessly linked with the wireless receiver.

3. The uninterruptible illumination system according to claim 2, wherein the power detection device comprises:
a wireless transmitter for radiating a signal to the wireless receiver;
an electricity provision element providing electricity to at least the wireless transmitter so that, when the electrical condition on the power supply line is not normal, the wireless transmitter is still capable of radiating the signal;
a power detection unit detecting the electrical condition on the power supply line and issuing an abnormality signal; and
a control unit providing a control signal to activate the wireless transmitter to radiate the signal when receiving the abnormality signal is received from the power detection unit.

4. The uninterruptible illumination system according to claim 3, wherein the power detection device further contains an AC transformer interfacing the power supply line.

5. The uninterruptible illumination system according to claim 1, further comprising at least a conduction switch connecting a lighting device to a power supply line.

6. The uninterruptible illumination system according to claim 1, wherein the driver and communication module provides uninterruptible power supply to the light generation element.

7. The uninterruptible illumination system according to claim 1, wherein the light generation element is one of a halogen lamp, an incandescent lamp, a fluorescent lamp, and a light emitting diode (LED).

8. The uninterruptible illumination system according to claim 1, wherein the lighting device is embodied as one of a light bulb, a lamp tube, and a recessed light fixture.
